(19) United States
(12) Patent Application Publication
(10) Pub. No.: US 2014/0379609 A1
(43) Pub. Date: Dec. 25, 2014

(54) METHOD AND SYSTEM FOR INSTANT PROCESSING OF AN SMS RELATED TO A BUSINESS

(71) Applicant: Infosys Limited, Bangalore (IN)

(72) Inventors: Mayank Shridhar, Ranchi (IN); Suresh Prahlad Bharadwaj, Bangalore (IN); Arun Sethia, Bangalore (IN)

(73) Assignee: Infosys Limited, Bangalore (IN)

(21) Appl. No.: 14/167,929

(22) Filed: Jan. 29, 2014

(30) Foreign Application Priority Data
Jun. 24, 2013 (IN) 2727/CHE/2013

(51) Int. Cl. G06Q 10/10; H04W 4/14

(52) U.S. Cl. CPC G06Q 10/107; H04W 4/14
USPC 705/345

(57) ABSTRACT

The present invention provides a method, system and computer program product for instant processing of business related operations. This invention is not restricted to any particular type of business. The system provides for means to interpret the business requirements at run time from an SMS sent by a user, and instantly get the business requirement executed and acknowledgment response sent to the user.

### FIELD

The field relates to handling business operations through SMS, and more specifically it relates to a method and system for instant processing of an SMS related to a business.

### BACKGROUND

As mobile applications and frameworks are being developed on a large-scale and the technology is moving from a nascent stage to rapidly attaining maturity, a lot of focus is given on user-experience and rich interfaces to make tasks easy for the user on smart-phones. These mobile applications may be used for both personal as well as business purposes.

However, for users who do not have computers or smart-phones but still need to perform business transactions using digital means, an SMS-based channel is one of the technologies that can be helpful. Many business use SMS based method for processing transactions. At present, such systems are custom-built for specific business, or for fixed business requirements. The mode of processing of the SMS may be synchronous or asynchronous where the response may or may not be sent immediately to the user.

The present systems are not equipped to instantly update the requestor. Also there is a need of a system which can take care of any type of business and its requirements.

### SUMMARY

In an embodiment, the present disclosure provides a method for instant processing of an SMS related to a business, wherein the method comprises receiving the SMS from a user using a first communication channel from a one or more communication channels, identifying the business and a one or more workflows of the identified business from the received SMS by a controller, executing the identified one or more workflows, by converting the received SMS into a request data structure relating to the identified business and each of the identified one or more workflows by a parser, determining if the request data structure is free of errors, using a one or more filters, when the one or more filters determine that the request data structure is free of errors, performing the following—performing the business transaction using the request data structure by an event handler, preparing a response data structure from the request data structure using the event handler, preparing a text response for the SMS based on the response data structure prepared by the event-handler using a formatter; and transmitting the prepared text response to the user using a second communication channel from the one or more communication channels.

In another embodiment, the disclosure also provides a system for instant processing of an SMS related to a business, wherein the system comprises a first communication channel from a one or more communication channels for receiving the SMS from a user at a computing system, a controller in the computing system for identifying the business and a one or more workflows of the identified business from the received SMS, executing the identified one or more workflows said executing comprising—a parser in the computing system for converting the received SMS into a request data structure relating to the identified business and each of the identified one or more workflows, a one or more filters in the computing system for determining if the request data structure is free of errors, when the one or more filters determine that the request data structure is free of errors,—an event handler in the computing system for performing the business transaction using the request data structure, the event handler for preparing a response data structure from the request data structure, a formatter in the computing system for preparing a text response for the SMS based on the response data structure prepared by the event-handler; and a second communication channel from the one or more communication channels for transmitting the prepared text response to the user.

In yet another embodiment, the disclosure also provides a computer program product comprising a non-transitory computer-readable medium having a computer-readable program product embodied therein for instant processing of an SMS related to a business, wherein the computer readable program product comprises program instruction means for receiving the SMS from a user using a first communication channel from a one or more communication channels, identifying the business and a one or more workflows of the identified business from the received SMS, by a controller, executing the identified one or more workflows said executing comprising—converting the received SMS into a request data structure relating to the identified business and each of the identified one or more workflow by a parser, determining if the request data structure is free of errors using a one or more filters, when the one or more filters determine that the request data structure is free of errors, performing the following—performing the business transaction using the request data structure by an event handler, preparing a response data structure from the request data structure using the event handler, preparing a text response for the SMS based on the response data structure prepared by the event-handler using a formatter; and transmitting the prepared text response to the user using a second communication channel from the one or more communication channels.

### BRIEF DESCRIPTION OF DRAWINGS

FIG. 1 is a flowchart briefly explaining the process of one embodiment of the present invention;

FIG. 2 is a data flow diagram for an embodiment of the present invention;

FIG. 3 is an Architecture Block Diagram showing all the Components and their Interactions of an embodiment of the present invention; and

FIG. 4 shows the structure of a system to implement an embodiment of the present system.

### DETAILED DESCRIPTION

The present invention relates to the businesses using SMS-based channel for various workflows in the business. In an example of retail business, workflow would relate to the processes behind—a retailer placing order for some products to the distributor or asking for the pricelist through an SMS. Another example can be a hospital sending current inventory count/status of medical devices to a pharmaceutical provider via an SMS, and also sending order for new supplies.

The present invention is not restricted to any business. This method and system can be used by any industry. As a part of the process, the workflow and the business are identified instantly when an SMS is received, and accordingly the SMS is processed.

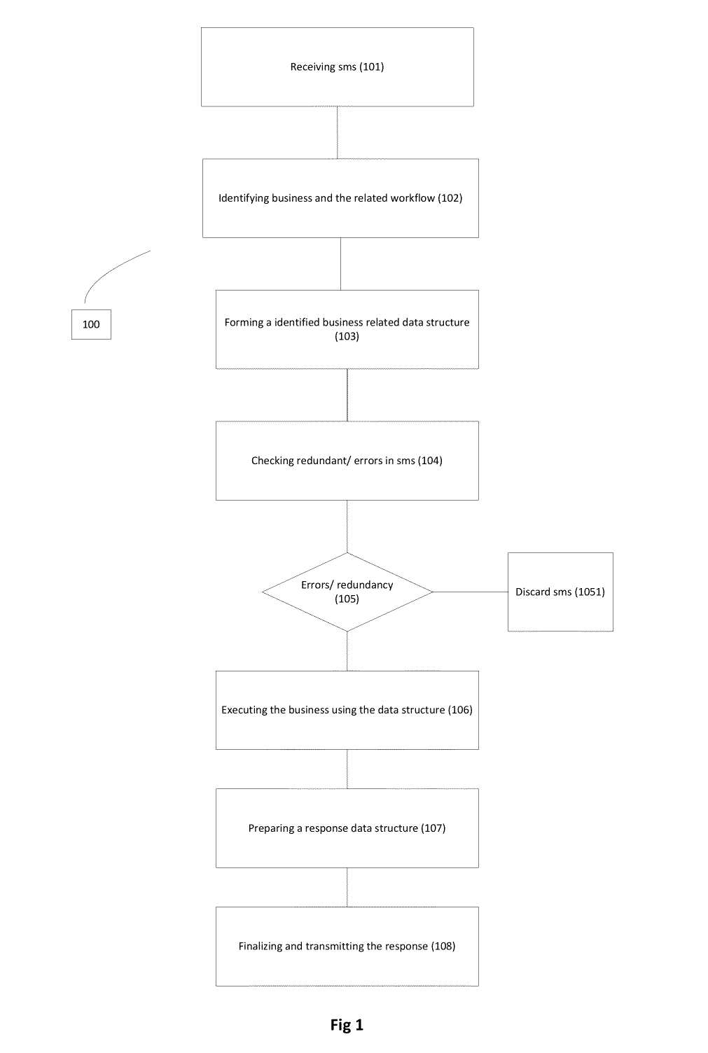

A preferred embodiment of the present invention is described in FIG. 1. A business has to be registered with this system for being able to use the SMS based channel for the services. In a preferred embodiment, the users also have to get themselves registered. In yet another preferred embodiment, each user will get a PIN to identify them.

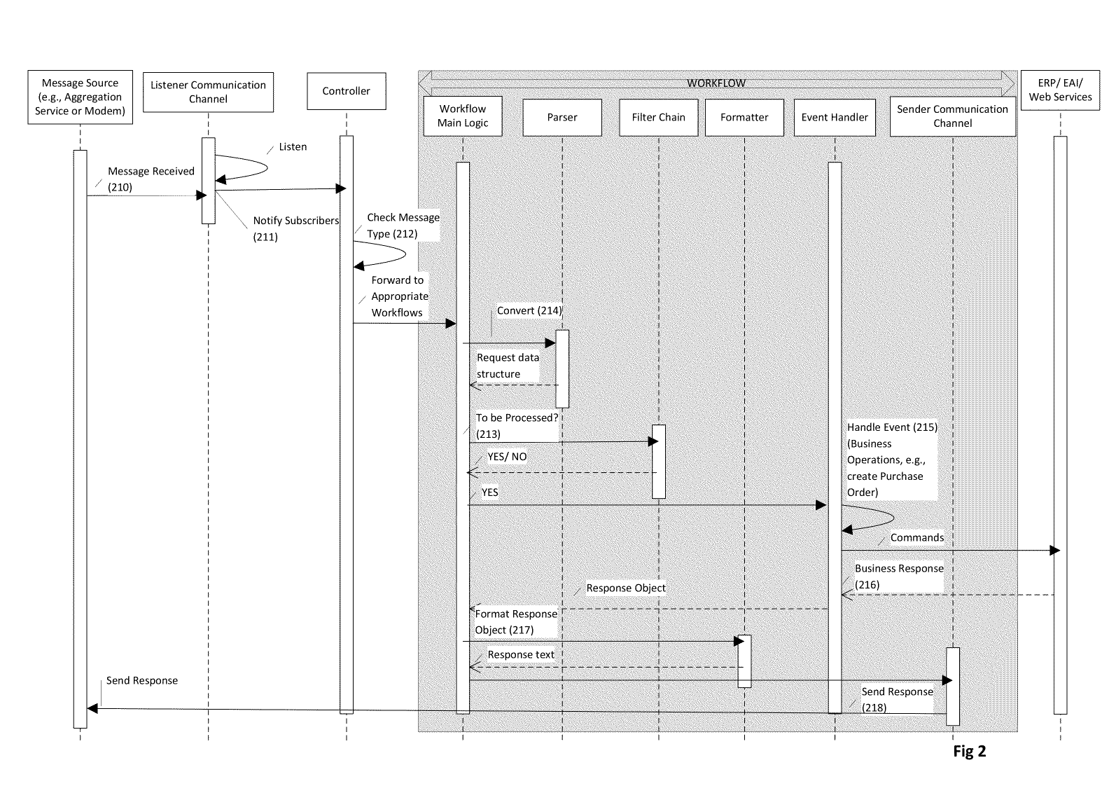

Each of the registered business has one or more workflows. A registered user can request for one or more workflows through an SMS. Each workflow will also relate to some parameters, example name of products, or the operation requested. Such parameters and workflow will be explained in detail with FIG. 2.

When a business user needs to send a query, he creates an SMS in a particular format and sends it to a predefined number (101). These SMS are received by some communication channels. The present invention employs multiple communication channels for the purpose of receiving such SMS. The SMS is received over a specific channel or protocol, which can be but not limited to TCP/IP, HTTP, USB or Serial.

These SMS are then sent for processing by a controller (102). The controller extracts some keywords from the SMS, to identify which business the SMS relates to and what are the workflows required. In one embodiment such keywords could relate to name of some products or name of brands, or the operation required. By extracting these keywords the controller will identify which business the SMS relates to. Once the business is identified the controller further identifies the workflows which the SMS is indicating to.

As per the identification the controller decides which workflow/s the data is to be routed to, for further processing.

Once the required workflow is identified, the SMS is routed to an appropriate parser in the system that converts the SMS into a request data structure (103). In an embodiment, the parser uses the keywords identified by the controller, for converting the SMS. In a preferred embodiment, in addition to the keyword extracted by the controller, the parser extracts the parameters and values for converting the SMS into a request data structure.

In one embodiment, a filter chain, or multiple filters in the system check for redundant request data structures, or if the SMS had any errors (104 & 105). It will check whether an SMS should be processed or not. In one embodiment, an SMS sent in duplicate, or if there is some mistake in the SMS, the filters will send an error message.

Once it is determined that the SMS is error free, an event handler executes the SMS business transaction using the request data structure (106). In an embodiment, the event handler initiates the actual business operations that need to be performed as per the SMS, and update in the business ERP.

After the business operation is performed, the event handler also creates a response data structure which may contain the acknowledgment of the operation performed, or if there was any information required in the SMS then it would be provided in the response (107).

A formatter creates an SMS for the response using the response data structure, and sends it back to the communication channel, which will transmit the response to the user (108).

Hence the present invention provides an instant way of interpreting, processing business SMS, and sending an acknowledgment back to the user.

We will now describe the process of the present invention in further detail, using an example of a specific business. For the purpose of better understanding, we shall use the example of retail. FIG. 2 describes the data flow in the present invention.

We shall take a use case here, defined as workflows—‘order creation’.

In an embodiment, once a business is registered with the system a cheat sheet is prepared. Such cheat sheet may contain various codes relating to the various workflows for the business. There may be codes for the various products also. These codes are used while creating an SMS for a particular operation or query. They can be made in any user convenient format. They may be of any varying length, and may be numeric, alphabetic, alphanumeric, or as convenient. In a preferred embodiment these sheets are configurable. They can be amended to add codes for any new product or process, or change the codes if any different format is decided to be used. These sheets are provided to the registered users for creating the SMS. For example in the retail industry, an example of cheat sheet can be—

| Items | |
|---|---|
| Oils | |
| ABC Olive Oil | A_Ol_O |
| XYZ Olive oil | X_Ol_O |
| MN Castor Oil | M_Ca_O |
| Process | |
| Order | 012 |
| Price | 013 |
| Exchange | 014 |
| Size | |
| 5 litres | 5 l |
| 2 litres | 2 l |
| 1 litre | 1 l |

Etc
Where ABC, XYZ etc is the brand name
So an example of an SMS could be <PIN of user>012 100 1l A_Ol_O
This would mean ordering 100 units of 1 litre ABC brand Olive Oil
This is only for the purpose of example. A person in the art may create SMS in any required different format, within the scope of the present disclosure. The format of the cheat sheet and the SMS can also keep changing as per the change in business requirements, or change in the products/brands or any such change.

When a registered user creates an SMS for a particular operation he desires, he uses the cheat sheet, and selects the appropriate code for the product or information he wants. In an embodiment, the registered users also have to add their PIN which they create during registration. Once the SMS is created in the right format, it is transmitted for further processing. One SMS can include codes for more than one workflow. The PIN maybe used to authenticate the user, and also extract his address and details in case he has ordered for items.

In one embodiment of the present invention, there may be two types of communication channels listener communication channel, and sender communication channel. The SMS from a registered user is received by a listener communication channel. Such communication channels, as discussed in description of FIG. 1, can be any of channels or protocols, example being HTTP, TCP/IP (210).

The controller then receives the message from the communication channel. This controller then extracts the short codes, and other keywords from the message. This extraction may be done using any string search or regular expression pattern matching process. On the basis of the keywords, the controller identifies the business, and the workflow or the operation desired by the user. (211 & 212)

For e.g., when the controller extracts keywords relating to orders in the above mentioned SMS example, it will know that the business is retail, and the workflow is relating to ordering products of a particular brand

In a preferred embodiment, this SMS is also checked for errors and duplicity. A filter chain checks if the same message has been sent more than once by mistake. It may also check if the codes are correct and the operation requested through the SMS is correct. If not, an error message may be sent to the user. The user may be required to send another SMS. (213)

After the SMS is checked for any errors, it is taken forward for processing. In one embodiment, a parser converts the SMS into a hierarchical data structure which defines what was the operation required and for what products. The parser extracts the parameters and the values from the SMS, for this purpose. In a preferred embodiment, for each workflow one request data structure will be created. The request data structure created for the workflows may be a tree structure which makes it easier for the execution of the workflow. The details of the workflow are available through the request data structure for execution. (214)

In one embodiment the request data structure is read by an event handler. The event handler takes inputs from the request data structure and executes the business transaction. (215) For example, in the SMS discussed above, the event handler initiates the order of 100 units of 1 litre ABC brand Olive Oil delivered to the user. The event handler will also update the database of the retail business to reflect 100 units being delivered. Accordingly, the SMS initially sent by the user is processed by the event handler, and the required operations are carried out. In a preferred embodiment, the event handler also ensures to create a response data structure for the operation carried out. The response data structure carries information to be provided to the user. In the example of ordering ABC brand olive oil, the response may contain acknowledgment that the products have been dispatched. Accordingly, a response data structure will be created. (216)

The response SMS is created from the response data structure, by a formatter. The formatter creates an acknowledgement or provides required information, as per the response data structure. In one embodiment the response SMS includes an identifier to be able to relate to request SMS. Such identifier may be in any required format. (217)

The response SMS is sent to the sender communication channel. In a preferred embodiment the sender communication channel is separate from the listener communication channel. The sender communication channel transmits the response SMS to the user. (218)

Hence the present invention can be configured for any business and for any workflow in the business. The user gets instant acknowledgment for the operations requested through the SMS.

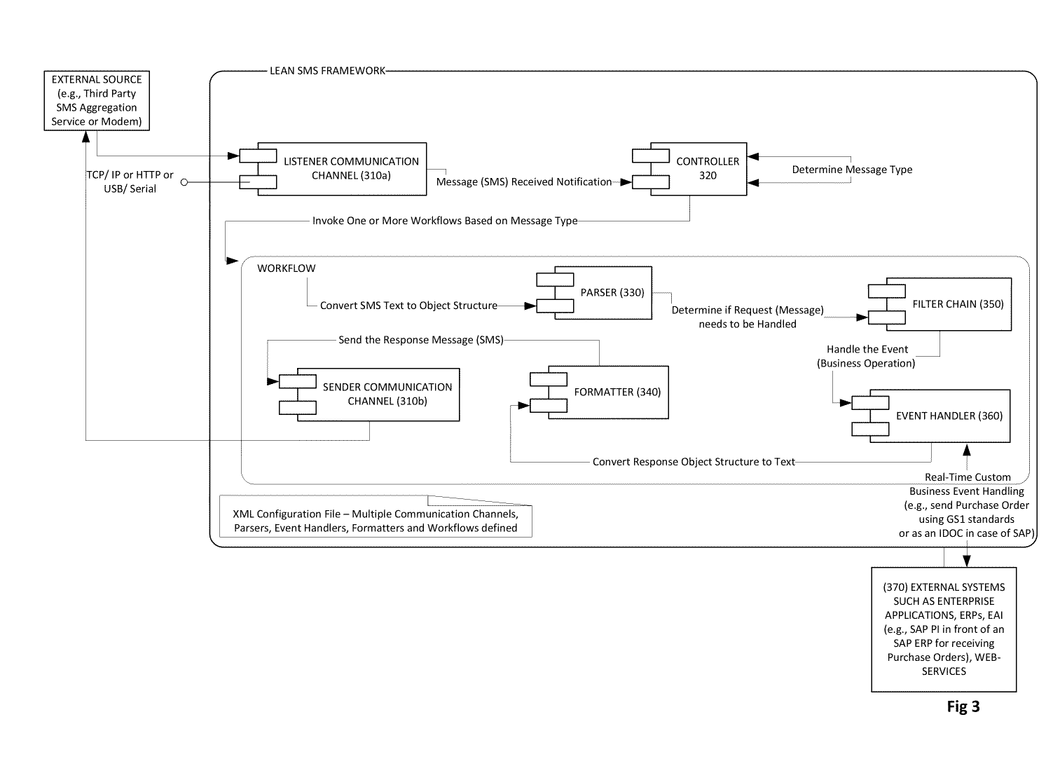

FIG. 3 describes architecture block diagram showing all the Components and their Interactions of a preferred embodiment of the present invention.

Communication Channels (310a & 310b): These entities are responsible receiving and sending messages from and to external entities, e.g., from SMS aggregator/gateway services or a USB/Serial modem. In a preferred embodiment, communication channels are of two types:
a. Listeners (310a): These entities will be responsible for receiving data over a specific channel/protocol, e.g., TCP/IP (Transmission Control Protocol/Internet Protocol), HTTP (Hyper Text Transfer Protocol), e.g., the Listeners can act as adapters for SMS aggregator-services, USB/Serial (for direct modems or phones with SIM cards attached to the server). Upon receiving data, they will raise events to be processed. The events can be raised for a plurality of messages in bulk, or for individual messages, depending on the configuration.
b. Senders (310b): These entities will be responsible for sending data (e.g., response messages) over a specific channel/protocol, e.g., TCP/IP, HTTP, USB/Serial.

Controller (320): in one embodiment, the Controller is a singleton entity responsible for deciding where the data has to be routed for handling. It will subscribe to all the Listener communication-channels for notification upon arrival of any data. Whenever any Listener communication-channel raises an event, the Controller receives the message-data and based on the keywords, identifies the business and the workflows. The Controller extracts keywords from the SMS to determine what kind of message has been received.

Based on the identification at the Controller, the SMS is processed appropriately at the following components—

Parsers (330): In one embodiment these entities are responsible for understanding the message received. The format in which messages are sent/received can keep varying for the type of operation and also over time based on new requirements; hence, the parsers will be responsible for abstracting the other layers and elements of the computing system from these nuances. Parsers will convert the data received by communication-channels into a hierarchical request data structure which the other layers of the system can comprehend and process.

Filters (350): These entities will determine whether a received message needs to be processed or not after executing some validations on the same. Filters can include but are not limited to checking if the message-type or format is supported, if it is a duplicate message being received or if it is a junk message.

Event Handlers (360): These are custom business-transaction handlers which handle a valid request data structure that has passed the other layers of the system (such as parsing and filtering). The handler initiates the actual business operation that needs to be performed in the enterprise system (370) and it may do so by using adapters for different ERPs (Enterprise Resource Planning)/enterprise systems or EAI (Enterprise Application Integration) tools. After handling an event, the handler will prepare a response data structure.

Formatters (340): These entities are responsible for creating the response message-text from a response object structure, which needs to be sent back to the original source of the message or a different destination.

The formatter (340) will convert the data structure into a text response and send it to the sender communication channel (310b).

The above defined system features are configurable. An XML configuration file defines the parsers, event handlers, formatters, communication channels, filters and workflows, as per the required business. Depending on the business using the present disclosure, the configuration file can be appropriately used.

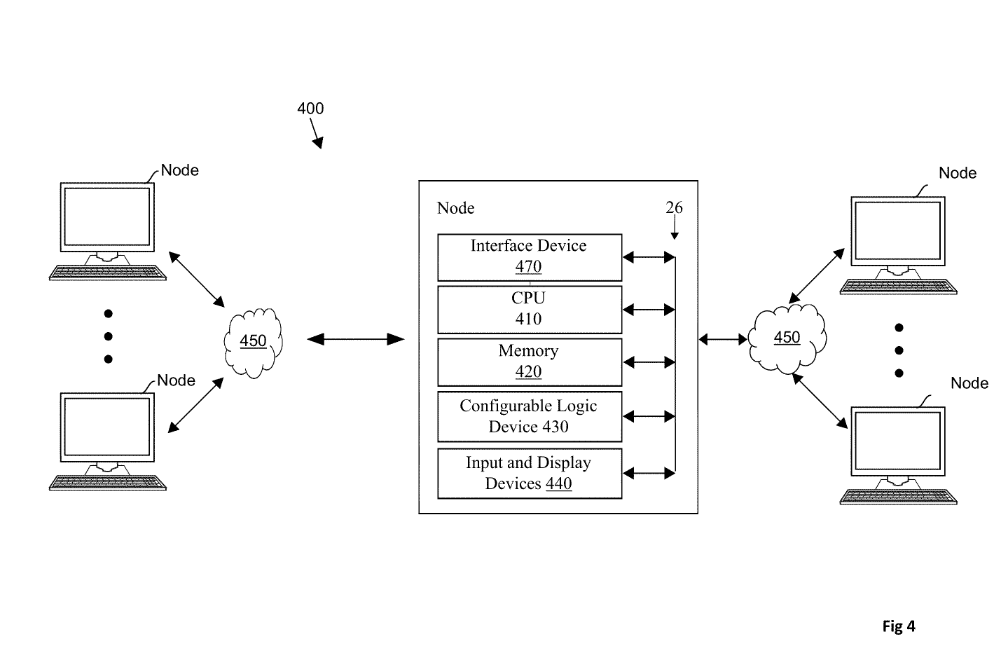

FIG. 4 describes the above system with a detail about the structure of client and server system. The client and server system are coupled together by Wide Area Network (WAN) 450, although the environment can include other types and numbers of devices, components, elements and communication networks in other topologies and deployments. While not shown, the exemplary environment may include additional components, such as routers, switches and other devices which are well known to those of ordinary skill in the art and thus will not be described here.

In the present disclosure the client refers to handheld devices. In a preferred embodiment, such handheld device includes mobile device.

The client interacts with the server WAN 450 although the interaction can be using any other network topologies. Additionally, the network can be hosted on a cloud or could be provided as a service.

The server systems includes at least one processor 410, memory 420, optional configurable logic 430, input and display devices 440, and interface device 470 which are coupled together by bus, although the nodes may comprise other types and numbers of elements in other configurations.

Processor(s) 410 may execute one or more computer-executable instructions stored in the memory 420 for the methods illustrated and described with reference to the examples herein, although the processor(s) 410 can execute other types and numbers of instructions and perform other types and numbers of operations. The processor(s) 410 may comprise one or more central processing units (“CPUs”) or general purpose processors with one or more processing cores, such as AMD® processor(s), although other types of processor(s) could be used (e.g., Intel®).

Memory 420 may comprise one or more tangible storage media, such as RAM, ROM, flash memory, CD-ROM, floppy disk, hard disk drive(s), solid state memory, DVD, or any other memory storage types or devices, including combinations thereof, which are known to those of ordinary skill in the art. Memory 420 may store one or more non-transitory computer-readable instructions of this technology as illustrated and described with reference to the examples herein that may be executed by the one or more processor(s). FIGS. 1 and 2 are representative of example steps or actions of this technology that may be embodied or expressed as one or more non-transitory computer or machine readable instructions stored in memory that may be executed by the processor(s) 410.

Input and display devices 440 enable a user, such as an administrator, to interact with the systems such as to input and/or view data and/or to configure, program and/or operate it by way of example only. Input devices may include a touch screen, keyboard and/or a computer mouse and display devices may include a computer monitor, although other types and numbers of input devices and display devices could be used. Additionally, the input and display devices can be used by the user, such as an administrator to develop applications using Application interface.

The interface device in the nodes is used to operatively couple and communicate between the nodes which are all coupled together by LAN and WAN. By way of example only TCP/IP can be over Ethernet and industry-standard protocols.

Although an exemplary environment with the client and server systems are described and illustrated herein, other types and numbers of systems, devices in other topologies can be used. It is to be understood that the systems of the examples described herein are for exemplary purposes, as many variations of the specific hardware and software used to implement the examples are possible, as will be appreciated by those skilled in the relevant art(s).

Furthermore, each of the systems of the examples may be conveniently implemented using one or more general purpose computer systems, microprocessors, digital signal processors, and micro-controllers, programmed according to the teachings of the examples, as described and illustrated herein, and as will be appreciated by those of ordinary skill in the art.

The examples may also be embodied as a non-transitory computer readable medium having instructions stored thereon for one or more aspects of the technology as described and illustrated by way of the examples herein, which when executed by a processor (or configurable hardware), cause the processor to carry out the steps necessary to implement the methods of the examples, as described and illustrated herein.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

We claim:

1. A method for instant processing of an SMS related to a business, wherein the method comprises:
receiving the SMS from a user using a first communication channel from a one or more communication channels;
identifying the business and a one or more workflows of the identified business from the received SMS, by a controller;
executing the identified one or more workflows, said executing comprising:
converting the received SMS into a request data structure relating to the identified business and each of the identified one or more workflows, by a parser;
determining if the request data structure is free of errors, using a one or more filters;
when the one or more filters determine that the request data structure is free of errors, performing the following—
performing the business transaction using the request data structure, by an event handler;
preparing a response data structure from the request data structure, using the event handler;
preparing a text response for the SMS based on the response data structure prepared by the event-handler, using a formatter; and
transmitting the prepared text response to the user using a second communication channel from the one or more communication channels.

2. The method as claimed in claim 1, wherein the method further comprises:
registering a business;
constructing one or more workflows for the registered business, each of the workflow having one or more parameters; and
assigning codes to each of the one or more parameters of the constructed workflow.

3. The method as claimed in claim 2, wherein the SMS comprises:
a code of a required parameter of the identified workflow; and
a user entered value of the required parameter.

4. The method as claimed in claim 3, wherein the step of identifying comprises extracting one or more keywords from the received SMS for identifying the one or more workflows.

5. The method as claimed in claim 1, wherein the step of determining if the request data structure is free of errors, further comprises determining if the SMS message has an error.

6. The method as claimed in claim 3, wherein the step of performing the business transaction comprises completing the identified one or more workflows using the codes, the required parameters and the user entered values of the required parameters, from the first data structure.

7. The method as claimed in claim 1, wherein the text response comprises:
a response identifier; and
a response message.

8. A system for instant processing of an SMS related to a business, wherein the system comprises:
a first communication channel from a one or more communication channels for receiving the SMS from a user, at a computing system;
a controller in the computing system for identifying the business and a one or more workflows of the identified business from the received SMS;
executing the identified one or more workflows, said executing comprising
a parser in the computing system for converting the received SMS into a request data structure relating to the identified business and each of the identified one or more workflows;
a one or more filters in the computing system for determining if the request data structure is free of errors;
when the one or more filters determine that the request data structure is free of errors,—
an event handler in the computing system for performing the business transaction using the request data structure;
the event handler for preparing a response data structure from the request data structure;
a formatter in the computing system for preparing a text response for the SMS based on the response data structure prepared by the event-handler; and
a second communication channel from the one or more communication channels for transmitting the prepared text response to the user.

9. The system as claimed in claim 8, wherein the system further comprises means configured for:
registering a business;
constructing one or more workflows for the registered business, each of the workflow having one or more parameters; and
assigning codes to each of the one or more parameters of the constructed workflow.

10. The system as claimed in claim 8, wherein the SMS comprises:
a code of a required parameter of the identified workflow; and
a user entered value of the required parameter.

11. The system as claimed in claim 10, wherein controller comprises means configured for extracting one or more keywords from the received SMS for identifying the one or more workflow.

12. The system as claimed in claim 8, wherein the step of determining if the request data structure is free of errors, further comprises determining if the SMS message has an error.

13. The system as claimed in claim 10, wherein the event handler comprises means configured for completing the identified one or more workflows using the codes, the required parameters and the user entered values of the required parameters, from the request data structure.

14. The system as claimed in claim 8, wherein the text response comprises:
a response identifier; and
a response message.

15. A computer program product comprising a non-transitory computer-readable medium having a computer-readable program product embodied therein for instant processing of an SMS related to a business, wherein the computer readable program product comprises program instruction means for:
receiving the SMS from a user using a first communication channel from a one or more communication channels;
identifying the business and a one or more workflow of the identified business from the received SMS, by a controller;
executing the identified one or more workflows, said executing comprising
converting the received SMS into a request data structure relating to the identified business and each of the identified one or more workflow, by a parser;
determining if the request data structure is free of errors, using a one or more filters;
when the one or more filters determine that the request data structure is free of errors, performing the following—
performing the business transaction using the request data structure, by an event handler;
preparing a response data structure from the request data structure, using the event handler;
preparing a text response for the SMS based on the response data structure prepared by the event-handler, using a formatter; and
transmitting the prepared text response to the user using a second communication channel from the one or more communication channels.

16. The computer program product as claimed in claim 15, wherein the program instruction further comprises means for:
registering a business;
constructing one or more workflows for the registered business, each of the workflow having one or more parameters; and
assigning codes to each of the one or more parameters of the constructed workflow.

17. The computer program product as claimed in claim 15, wherein the SMS comprises:
a code of a required parameter of the identified workflow; and
a user entered value of the required parameter.

18. The computer program product as claimed in claim 17, wherein the program instruction means for identifying, further comprises means for extracting one or more keywords from the received SMS for identifying the one or more workflow.

19. The computer program product as claimed in claim 15, wherein the program instruction means for determining if the data structure is free of errors, further comprises determining if the SMS message has an error.

20. The computer program product as claimed in claim 17, wherein the program instruction means for executing, further comprises means for completing the identified one or more workflow using the codes, the required parameters and the user entered values of the required parameters, from the first data structure.

21. The computer program product as claimed in claim 15, wherein the text response comprises:
a response identifier; and
a response message.
